(19) United States
(12) Patent Application Publication
(10) Pub. No.: US 2013/0346672 A1
(43) Pub. Date: Dec. 26, 2013

(54) Multi-Tiered Cache with Storage Medium Awareness

(71) Applicants: Sudipta Sengupta, Redmond, WA (US); Jin Li, Bellevue, WA (US); Cheng Huang, Redmond, WA (US); Timothy Andrew Pritchett, West Lafayette, IN (US); Christopher Broder Wilson, Santa Barbara, CA (US)

(72) Inventors: Sudipta Sengupta, Redmond, WA (US); Jin Li, Bellevue, WA (US); Cheng Huang, Redmond, WA (US); Timothy Andrew Pritchett, West Lafayette, IN (US); Christopher Broder Wilson, Santa Barbara, CA (US)

(73) Assignee: MICROSOFT CORPORATION, Redmond, WA (US)

(21) Appl. No.: 13/531,455

(22) Filed: Jun. 22, 2012

(51) Int. Cl. G06F 12/02; G06F 12/08

(52) U.S. Cl. 711/103; 711/122; 711/E12.008; 711/E12.024

(57) ABSTRACT

The subject disclosure is directed towards a multi-tiered cache having cache tiers with different access properties. Objects are written to a selected a tier of the cache based upon object-related properties and/or cache-related properties. In one aspect, objects are stored in an active log among a plurality of logs. The active log is sealed upon reaching a target size, with a new active log opened. Garbage collecting is performed on a sealed log, such as the sealed log with the most garbage therein.

### BACKGROUND

The concept of using a data cache for significantly faster data access is well known in computing technology. For example, current computer-related storage systems tend to use one or two layers of caching in a storage hierarchy, e.g., a RAM cache above a hard disk, and a hard disk cache above a network connection. Most caching solutions are thus based upon techniques for RAM or hard disk caching.

Solid-state nonvolatile memory (e.g., flash memory) comprises a relatively new type of storage media whose peculiarities with respect to handling data writes makes solid-state device memory particularly inappropriate for use with caching algorithms that were designed for RAM or hard disk caches. For example, the cost of solid-state device memory per storage unit is considerably higher than hard disk cost. Further, solid-state storage class devices are not configured for byte-level access, but rather page-based access, with page-based copy on write and garbage collection techniques used, which slows down access and causes increased device wear.

With respect to solid-state device wear, solid-state device media wearing from data writes makes a solid-state device-based cache unsuitable for use in as a cache with a high amount of churn, as the correspondingly large amount of data writes results in a significantly decreased solid-state device lifetime. As a result, a solid-state device may not last up to the next hardware replacement cycle in a data center, for example. Note that multi-level cell (MLC) flash devices are on the order of three to four times less expensive than single-level cell (SLC) flash devices, and while this may mitigate some cost considerations, MLC flash devices have a shorter device lifetime than SLC flash devices.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which objects are written to a multi-tiered cache having cache tiers with different access properties. Objects are written to a selected tier of the cache based upon object-related properties and/or cache-related properties.

In one aspect, a cache hierarchy includes a plurality of tiers having different access properties, including a volatile cache tier and at least one non-volatile cache tier. Objects are associated with object scores and each tier is associated with a minimum access scoring threshold. Each object is stored in a highest priority level tier having a minimum access scoring threshold that allows storing the object based on the object score.

In one aspect, there is described maintaining a plurality of logs, including writing objects to an active log. The active log is sealed upon reaching a target size, with a new active log opened. Garbage collecting is performed on a sealed log, which may be selected based on an amount of garbage therein relative to the amount of garbage in at least one other sealed log.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a multi-tiered cache according to one example embodiment.

FIGS. 2A and 2B are representations of cache-related components that manage data in the multi-tiered cache according to one example embodiment.

FIG. 3 is a flow diagram representing example steps that may be taken to allocate an object to a cache tier according to one example embodiment.

FIG. 4 is a flow diagram representing example steps that may be taken to determine whether to enter an object into a solid state device cache tier according to one example embodiment.

FIG. 5 is a flow diagram representing example steps that may be taken to manage objects in log structures according to one example embodiment.

FIG. 6 is a block diagram representing an example computing environment into which aspects of the subject matter described herein may be incorporated.

### DETAILED DESCRIPTION

Various aspects of the technology described herein are generally directed towards a cache management technology that is aware of object properties and storage media characteristics, including solid-state device properties. The technology is based upon organizing storage in a tiered cache of layers across RAM, solid-state device memory, and (possibly) hard disk based upon the storage media characteristics and/or object properties. In one aspect, the storage is managed to make the solid-state device media device last a desired lifetime.

In one aspect, the technology considers specific properties, e.g., cost, capacity, access properties such as set up time (seek time, control setup time) of the caches, and the throughput of the cache of each type of media (RAM, solid-state device memory, hard disk) and/or object properties (size, access patterns) to optimize placement of cached data in an appropriate tier of the cache. The technology attempts to optimize for the properties for each type of storage media for caching data in a tiered caching hierarchy. For example, in one embodiment, only frequently used (“hot”) objects are written to solid-state device, the solid-state device is organized into a multiple log structured organization, and a configurable write budget policy is enforced to control device lifetime.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and dynamic recognition in general.

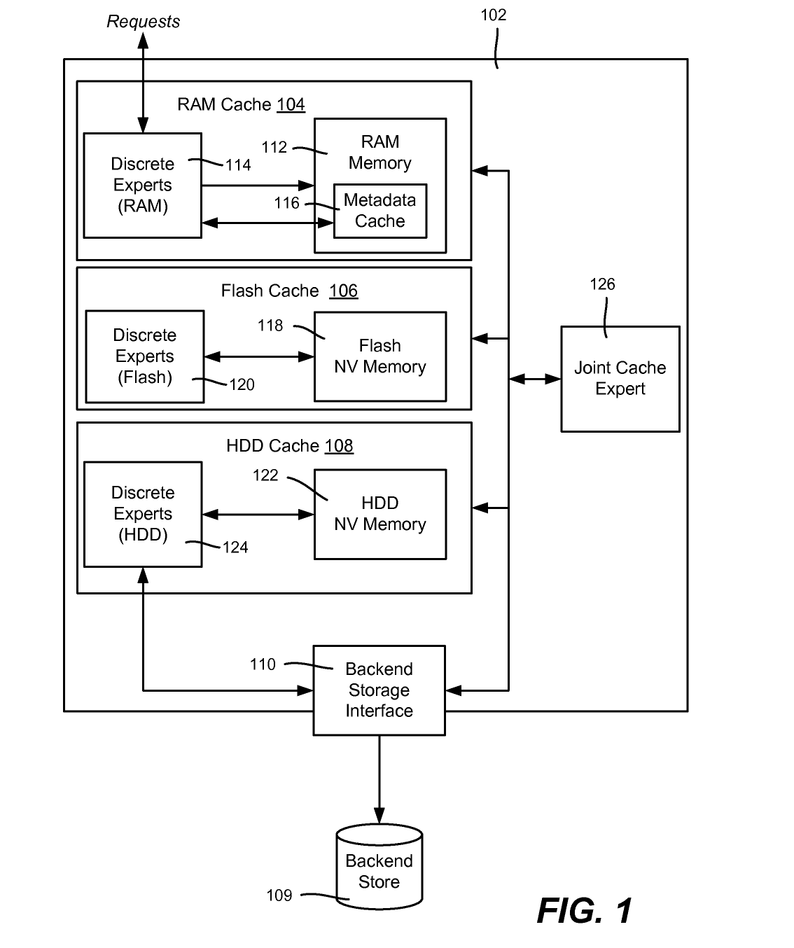

FIG. 1 shows a block diagram comprising an example implementation of a cache hierarchy 102 comprising a RAM cache 104, a solid-state device cache 106, and a hard disk drive cache 108. Note that in this example implementation, a hard disk is used as a cached for a backend storage mechanism 109 accessed via a backend storage interface 110, e.g., a network drive/cloud storage that may act as the “ground truth” with respect to any object maintained therein. In alternative implementations, a hard disk may act as the ground truth, in which event the RAM cache and solid-state device cache form the cache hierarchy above the “ground truth” hard drive.

It should be noted that rather than using a write-through cache with respect to an object being written to ground truth storage, a write-back caching model may be used, in which any “dirty” (modified or created) object need only have the dirtied object maintained in any non-volatile storage. This leverages the non-volatility of the solid-state device cache and any hard disk cache, as no dirtied object is lost in the event of power failure. A clean object that is unchanged with respect to the object as backed in a non-volatile storage may reside in RAM, as loss of such an object from a power failure will not matter.

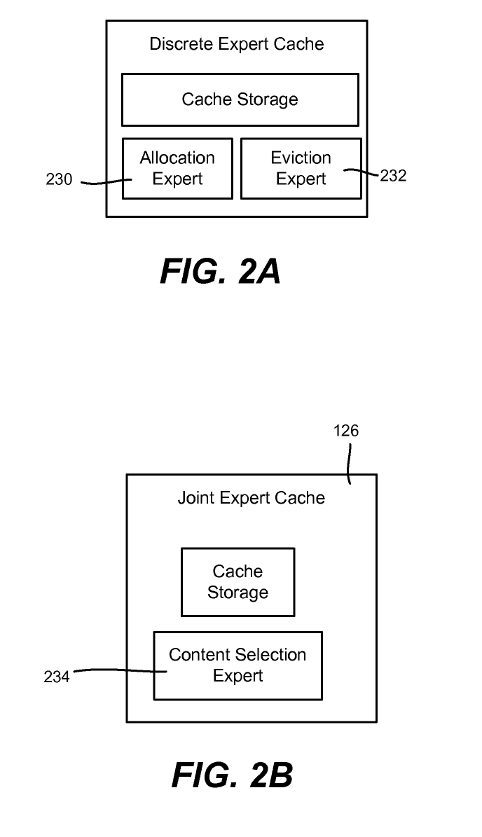

As represented in FIGS. 1 and 2A, each cache can be considered as an expert cache that includes memory and discrete (per-cache) experts 230 and 232 (FIG. 2A). Thus, the RAM cache 104 includes an amount of RAM (random access memory) 112, and discrete RAM cache experts 114. The RAM memory also includes a metadata cache 116 as described herein. The solid-state device cache 106 includes nonvolatile (NV) solid-state device memory 118 and discrete solid-state device experts 120 and the hard disk drive (HDD) cache 108 includes nonvolatile hard disk storage/memory 122 and discrete solid-state device experts 124.

As represented in FIGS. 1 and 2B, a joint expert cache 126 including a content selection expert 234 is provided. Operations of the various components are described below, but in general can be considered as directed towards moving the data among the tiers while enforcing policies. In one implementation, a unified object scoring mechanism is used to decide which objects enter which layer of the multi-tiered cache and which objects are evicted out of respective layers. For example, each cache tier may be assigned a priority and a minimum access scoring threshold, with an object stored in the highest priority cache tier in which its access score is higher than a minimum access scoring threshold of that cache tier; example scoring algorithms are described below. The minimum access scoring threshold for a cache tier may be dynamically adjusted, e.g., based upon the object access score of the bottom X-percentile of objects in cache, such as one percent. Sampling (e.g., random sampling) may be used to estimate the minimum access scoring threshold, e.g., for ten thousand objects or some other number that is reasonable for the cache tier.

Turning to a description of the flow of objects through the cache hierarchy, initially, as the system starts out, objects are cached in RAM 112. The RAM metadata cache 116 may be used to track the hotness (the hit count) of objects, whether they are cached or not. When evicted, objects in the RAM that are sufficiently hot (after having established their hotness as tracked in the RAM metadata cache) are attempted to be copied into the solid-state device cache.

More particularly, eventually the RAM cache will fill up to some threshold level (e.g., ninety percent full), whereby one or more objects need to be evicted from the RAM 112 to bring the RAM 112 to a less full state (e.g., eighty percent full). Objects to be evicted are selected by the corresponding tier's eviction expert as described below.

Note that in a typical system there are likely too many objects to have a metadata cache to track the hit count/score of each object. Instead, as described herein, the metadata cache may be sized to handle a limited number of objects, which, for example, may be based upon as some multiple of the solid-state device memory's capacity, e.g., two times, or four times. For example, if the solid-state device capacity is generally sufficient to cache ten million objects, the metadata cache may be sized to contain twenty (or forty) million entries. The size of the metadata cache may be adaptively resized (e.g., based on thrashing rate and/or hit rate).

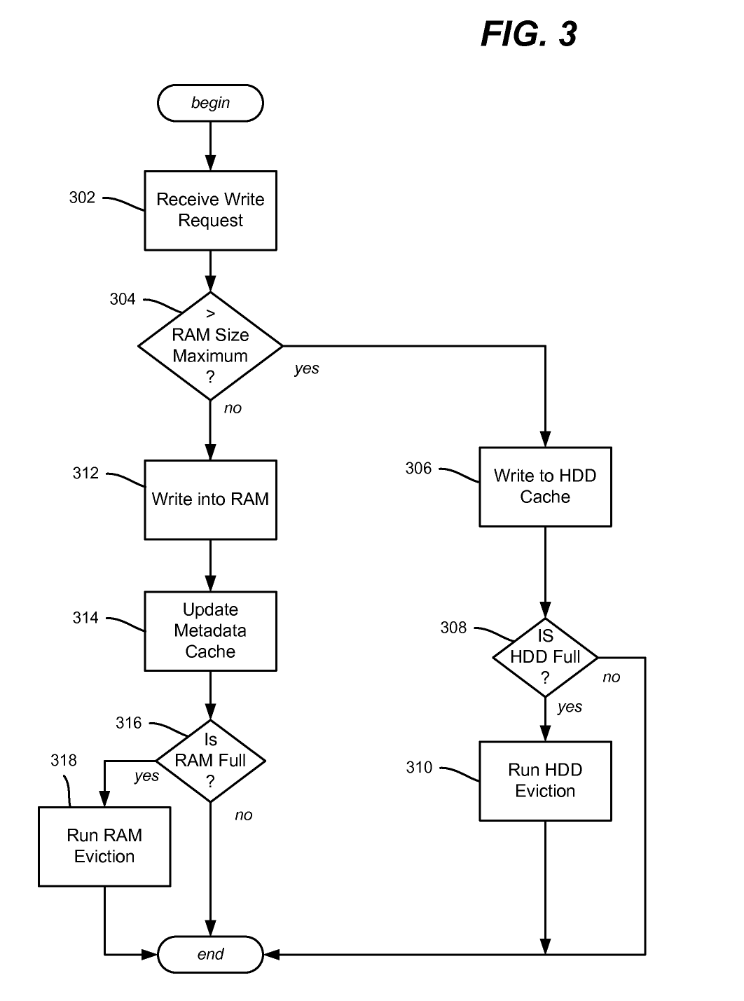

FIG. 3 summarizes some example steps with decisions made to allocating on object for RAM caching, beginning at step 302 where a write request is received. If at step 304 the object is too large with respect to a maximum allowed object size in RAM, the object is written to the hard disk cache via step 306. Note that this assumes that if an object is too large for RAM, the object is also above a size maximum for the solid-state device cache; (if not, then solid-state device entry as described below may be possible).

Steps 308 and 310 represent considering whether to evict objects from the hard drive cache. Note that unlike the example represented in FIG. 3, in other implementations these steps may not occur with each write to the hard drive, but rather in accordance with some eviction policy, such as triggered by a percentage occupancy of the hard drive cache.

Step 312 represents writing the object into the RAM cache, with step 314 representing the updating of the metadata cache to reflect that the object that now exists in the RAM cache has been accessed.

For any cache it is feasible to use selective allocation that is integrated with eviction. For example, space may be allocated a new object only if the score is higher than the worst scored object currently in the cache (example scoring is described below). Thus, if such a mechanism is in place, an attempt to write the object into solid-state device or the hard drive may be made instead.

Steps 316 and 318 are directed towards determining whether the RAM cache is full and an eviction operation needs to be performed. Note that step 316 need not be performed on each write to the RAM cache, but rather based upon some other triggering mechanism.

In general, eviction from any cache is based upon finding the objects having the lowest scores. A score can be a hit count, or a more complex value based upon other factors.

More particularly, instead of valuing an object based on a score that is only a hit count, more complex object scoring may be used to determine whether to evict an object from a given cache. One general score formula for an object is based on its access-likelihood (e.g., a hit count of access with some aging adjustment) times the retrieval cost of the object (e.g., a delta between solid-state device access time and hard disk access time) divided by the benefit of evicting the object from the cache, (e.g., the larger the size of the object, the more space freed up by eviction.

This may be represented as:

Score(p)=L(p)*C(p,c)/B(p),

in which L(p) is the access-likelihood of object p, C(p, c) is the retrieval cost of object p for cache tier c, and B(p) is the benefit from evicting object p from cache.

The retrieval cost may be computed as:

C(p,c)=seek_{cl}−seek_{c}+size(p)/throughput_{cl}−size(p)/throughput_{c},

where C(p, c) is the difference of the retrieval cost, c is the cache tier to be evaluated, cl is the lower priority cache tier, seek, is the set up time of the cache tier to be evaluated, seek_{cl} is the set up time of the lower cache tier, size(p) is the size of the object, and throughput_{c} is the throughput of cache device c. The benefit B(p) from evicting the object p from cache may be the size of the object, B(p)=size(p).

Another suitable scoring algorithm for an object p comprises:

Score(p)=freq(p)*Delta-Access-time(p)/size(p).

Such a score can be computed on demand, which allows for factoring in aging as part of freq(p) into the above scoring algorithm.

Note that frequency values are stored with a limited number of bits (and thus have a maximum frequency value). Each time the object is accessed, the access frequency value is incremented, up to the maximum. Periodically, the access frequency value of all objects may be reduced, e.g., by half.

Real-time eviction is one option, e.g., searching the cache metadata with the key being an object score to find the lowest scored object. As a new object comes in, the object having the lowest score is evicted to the solid-state device cache or hard drive as described herein.

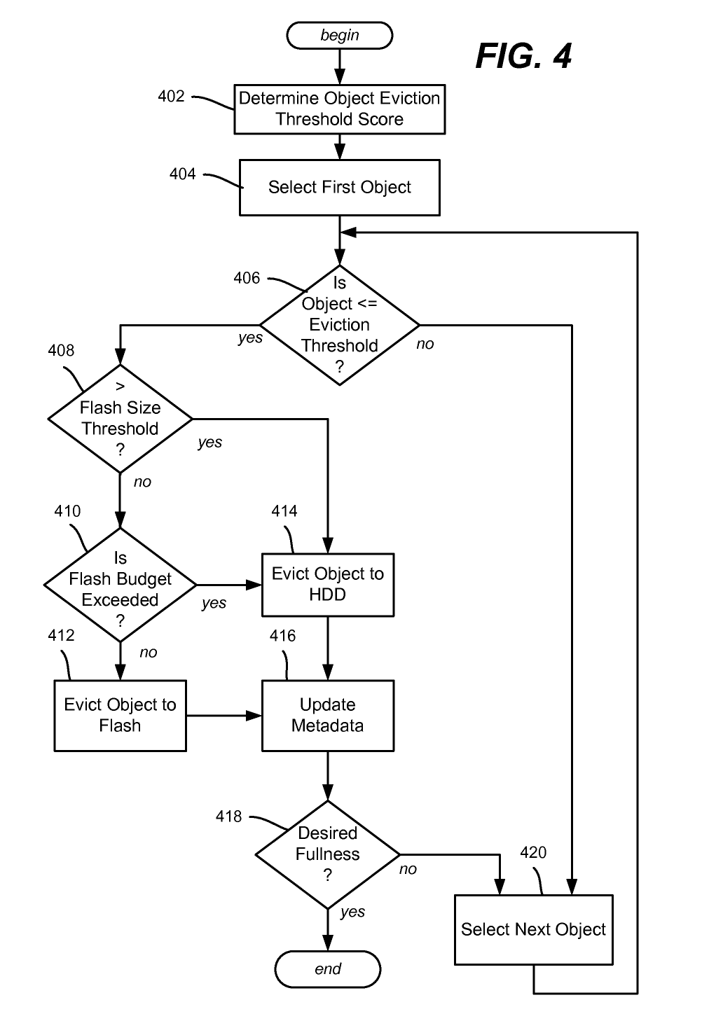

FIG. 4 represents a batch eviction alternative to real-time eviction, which, for efficiency, batch evicts multiple objects when a threshold cache occupancy value is reached; e.g., approximately ninety percent occupancy triggers a batch eviction operation, which operates to reduce the cache to approximately eighty percent occupancy. To determine a threshold eviction score (step 402), in one implementation the eviction score may be proportional to the minimum access scoring threshold of the cache tier. Alternatively, a new sample of the scores for some number of objects may be taken.

Then, starting at a random location and a first object at that location, for example (step 404), objects at or below the eviction threshold score are evicted via step 406. Eviction continues via steps 418 and 420 until the desired level of occupancy is reached; (in the unlikely event that the sampling was such that not enough objects were evicted, a new sample may be taken). Starting at the random location ensures that over time no object will escape an eviction evaluation.

As described herein, objects that are evicted from the RAM cache 104, e.g., those least recently used or least frequently used, only enter the solid-state device cache 106 if they have established their hotness. Otherwise, such objects enter the hard disk cache 108. Other criteria for entering the solid-state device cache 106 need to be met, including meeting a solid-state device budget policy (described below) and an object size limitation (step 408). More particularly, objects beyond a certain (configurable) size threshold are not entered into the solid-state device cache tier 106. This is generally because hard disks work well for sequential access of large objects by amortizing seek times over transfer times, and entering such objects into the solid-state device cache tier 106 does not provide access times that justify the cost of writing to solid-state device, as determined by an administrator or the like who sets the threshold size, e.g., via experimentation, analysis, tuning, and/or the like.

Note that hotness may be combined with the solid-state device budget evaluation (step 410), as described below. Thus steps 408 and 410 need to be met before eviction to the solid-state device occurs at step 412; (a “not less than the lowest score” rule may also be enforced). Otherwise eviction is to the hard drive at step 414. Step 416 represents updating the metadata/any indexes as appropriate, e.g., to reflect the eviction.

Turning to write budgeting with respect to solid-state device cache writes, the amount of writes to the solid-state device is controllable to avoid wear by enforcing a budget per time period, such as writes per day or writes per hour, or the like. In general, when there is no more write-budget left within a period, writes are denied until the budget is refilled in the next period. Unused budget may rollover into the next time period.

In one implementation, a starting budget value (number of allowed writes) per time period may be based upon a desired lifetime of the solid-state device, based on predicted lifetimes for different solid-state device media, and/or for writes relative to reads. This value may change over time based upon actual usage, e.g., during a transition time. For example, if budget is unused (or is tending to be unused over multiple time periods), the threshold score (or hit count) of an object that needs to be met for writing to the solid-state device may be decreased. Conversely, if a budget is denying writes (or is tending to deny writes over multiple time periods), the threshold score for entering the cache may be increased. Thus, the budget policy provides for adaptively adjusting the value of writes to naturally maximize performance while not exceeding media durability.

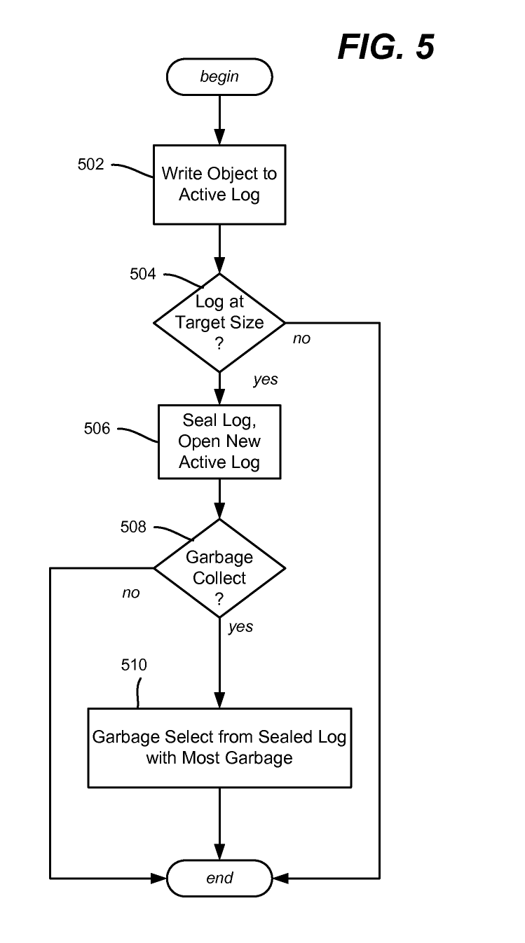

As represented in FIG. 5, in one implementation the solid-state device cache (and/or hard drive) is arranged to store data in a log structured manner, in which multiple logs may be used, each with a target size, with sequential writes to a currently active log. The number of logs is configurable, e.g., there may be on the order of one-hundred 1 GB logs in a solid-state device cache having a 100 GB capacity. Step 502 represents writing an object to an active log.

In one implementation, to avoid excessive data movement within the solid-state device (or hard drive), which causes wear, when the target size of the active log is reached as evaluated at step 504, at step 506 the active log is sealed (from new writes) and a new log for writes opened to be the currently active log.

As sealed logs do not receive writes but can have objects evicted therefrom by marking them as deleted for later garbage collection, over time sealed logs become more and more sparse with respect to useable data. Garbage collection, represented by steps 508 and 510 in FIG. 5, is thus performed to clean up sparse logs. Note that while FIG. 5 exemplifies determining whether to garbage collect only when a log is sealed and a new active log is opened, such a determination may be made at any time, such as after any write, or made independently of any log sealing/opening activity and/or any write activity.

In one implementation as represented by step 510, garbage collection is only performed with respect to which one of the sealed logs has the most garbage (is the most sparse), by copying non-evicted data to the active log. The garbage collected sealed log's storage space may then be reclaimed for subsequent allocation. Objects evicted out of solid-state device cache 106 enter the hard disk cache 108. Objects evicted from the hard disk cache may be discarded, as long as a ground truth storage layer exists elsewhere, e.g., elsewhere on the hard disk, in a cloud storage, a server, and the like.

Via the backend storage interface 110, the durability of writes can be guaranteed by always writing objects to the backend store 109 (using a “write-through” policy) and invalidating object copies in the cache hierarchy 102. Alternatively, the nonvolatile nature of some layers of the cache hierarchy 102 allow a “write-back” policy to the backend store 109. Thus, in this alternative, different layers in the multi-tiered cache may contain different versions of the object. Because lookups check the hierarchy in order, from RAM to solid-state device to hard disk, the timeline of versions for the same object in the cache need to follow this order, with the most recent version in the highest layer (among the layers where it is present).

As can be seen, there is described a multi-tiered, multi-storage media cache hierarchy that leverages the benefits/peculiarities of each type of storage medium. For example, to achieve a desired solid-state device lifetime, a write budget policy may be built into an object scoring function so that cache churn rate (insertion and eviction) decisions are made without wearing out the device faster than desired.

The cache hierarchy is also aware of an object's properties (e.g., object size and access patterns such as hot or cold, random or sequential, read or write) in deciding where to place the object in the cache hierarchy. For example, a metadata cache is used to track the hotness of some number of objects (e.g., based on a multiple of the cache size), with a write allocation in the cache only made when the object proves itself to be hot. This is particularly applicable to the solid-state device cache because writes reduce solid-state device lifetime.

Also described is a multi-log structured organization of variable sized objects on secondary storage (solid-state device or hard disk); only one log is active at a time for sequential writes. Logs are garbage collected in “highest fraction of garbage content” order first.

### Example Operating Environment

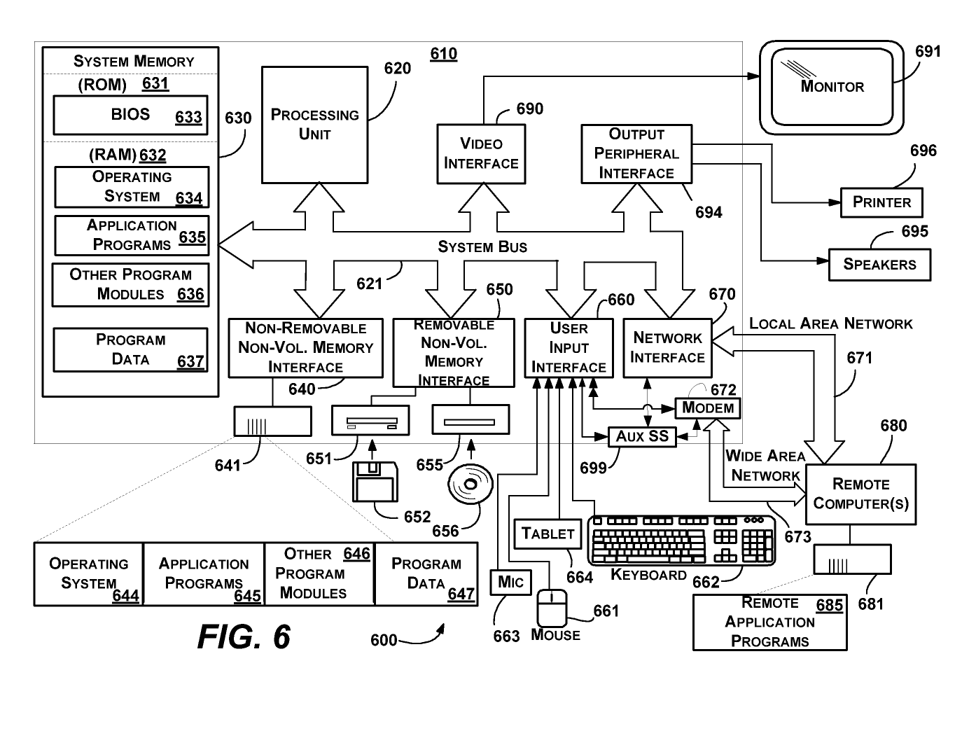

FIG. 6 illustrates an example of a suitable computing and networking environment 600 into which the examples and implementations of any of FIGS. 1-5 may be implemented, for example. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the example operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an example system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, solid-state device memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the example operating environment include, but are not limited to, magnetic tape cassettes, solid-state device memory cards, digital versatile disks, digital video tape, solid-state RAM, solid-state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are examples and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising, writing objects to a multi-tiered cache having cache tiers with different access properties, including for at least some of the objects, selecting a tier of the cache for writing each object based upon object-related properties or cache-related properties, or both object-related properties and cache-related properties.

2. The method of claim 1 wherein selecting the tier of the cache for writing each object based upon object-related properties comprises selecting the tier based upon object size or object access scoring, or both object size and object access scoring.

3. The method of claim 1 wherein selecting the tier of the cache for writing each object based upon cache-related properties comprises selecting the tier based upon cache capacity or cache media properties, or both cache capacity and cache media properties.

4. The method of claim 1 wherein selecting a tier of the cache for writing each object based upon access properties of the caches comprises selecting the tier based upon cache throughput, cache access time or cache transfer time, or any combination of cache throughput, cache access time or cache transfer time.

5. The method of claim 1 further comprising, assigning each cache tier a priority level and a minimum access scoring threshold, and storing an object in the highest priority level cache tier that has an access score higher than the minimum access scoring threshold of that cache tier.

6. The method of claim 5 further comprising, determining an object access score score for an object with respect to a cache tier based upon the access-likelihood of the object, the retrieval cost of the object for the cache tier, and the benefit of evicting the object from the cache tier.

7. The method of claim 6 further comprising computing the retrieval cost based upon a size of the object, throughput of the cache tier, cache access time or cache transfer time, or any combination of a size of the object, throughput of the cache tier, cache access time or cache transfer time.

8. The method of claim 6 further comprising computing the benefit based upon a size of the object.

9. The method of claim 6 further comprising computing the access likelihood of the object based upon a frequency value that is incremented up to a maximum when the object is accessed, and periodically or occasionally reduced.

10. The method of claim 5 further comprising dynamically adjusting the minimum access scoring threshold of a cache tier based upon the object access score of a plurality of lowest score objects in the cache tier.

11. The method of claim 10, further comprising sampling a plurality of object scores to estimate the minimum access scoring threshold.

12. The method of claim 11, further comprising adjusting the minimum access scoring threshold based upon a write budget, including raising the minimum access scoring threshold if the write budget is exceeded.

13. The method of claim 1 further comprising, evicting one or more objects from a cache tier when the cache tier reaches a preset occupancy level.

14. The method of claim 13, wherein evicting the one or more objects comprises determining an eviction score and scanning through the cache tier to evict objects based on the eviction score.

15. The method of claim 14 wherein determining the eviction score comprises setting the eviction score based upon a minimum access scoring threshold of the cache tier.

16. A system comprising, a cache hierarchy including a plurality of tiers having different access properties, including a volatile cache tier and at least one non-volatile cache tier, in which objects are associated with object scores and each tier is associated with a minimum access scoring threshold, and each object is stored in a highest priority level tier having a minimum access scoring threshold that allows storing the object based on the object score.

17. The system of claim 16 wherein the tiered cache includes a volatile RAM cache assigned a highest priority, and a non-volatile solid-state drive cache assigned a next highest priority.

18. The system of claim 17 wherein the tiered cache includes a non-volatile hard drive cache assigned a lower priority than the non-volatile solid-state priority, and a backend storage infrastructure assigned a lower priority than the hard drive cache priority.

19. One or more computer-readable media having computer-executable instructions, which when executed perform steps, comprising, maintaining a plurality of logs, including writing objects to an active log, sealing the active log upon reaching a target size and opening a new active log, and garbage collecting from a sealed log.

20. The one or more computer-readable media of claim 17 wherein garbage collecting from the sealed log comprises selecting a sealed log based on an amount of garbage therein relative to at least one other sealed log.
